(19) United States
(12) Patent Application Publication
(10) Pub. No.: US 2013/0333955 A1
(43) Pub. Date: Dec. 19, 2013

(54) Scales, And Methods Of Use Thereof

(71) Applicant: Rosalie Annette Jefferson, Dallas, TX (US)

(72) Inventor: Rosalie Annette Jefferson, Dallas, TX (US)

(21) Appl. No.: 13/524,930

(22) Filed: Jun. 15, 2012

(51) Int. Cl. G01G 23/18

(52) U.S. Cl. 177/1; 177/45

(57) ABSTRACT

Improved scales, and methods of use thereof, are provided. In one embodiment, a scale includes a platform for a user to step thereon, and a display adapted to display a weight of the user. The display is further adapted to display a message from one of a set of message categories at least when the user is on the platform.

### TECHNICAL FIELD

The illustrative embodiments relate generally to scales, and more particularly, improved scales that display one or more messages, and methods of use thereof.

### BACKGROUND

Scales are widely used to determine one's weight, as well as other body measurements such as body mass index (BMI). Modern scales have adopted digital technologies that allow for an electronic display, which may be used to present a user's weight and other body measurements. However, current scales fail to display messages, from one or more different message categories, to the user in a flexible and readable manner. Current scales may also fail to allow for a user to conveniently and easily change message categories from which to display messages on the scale. Indeed, current scales may suffer from other issues and drawbacks as well.

### SUMMARY

According to an illustrative embodiment, a scale includes a platform for a user to step thereon, and a display adapted to display a weight of the user. The display is further adapted to display a message from one of a set of message categories at least when the user is on the platform.

According to another illustrative embodiment, a scale includes a platform for a user to step thereon, and a display adapted to display a weight of the user. The display is further adapted to display a quote from one of a set of quote categories at least when the user is on the platform.

According to another illustrative embodiment, a method for displaying data on a scale includes detecting that a user has stepped on the scale, determining a weight of the user, and displaying the weight and a text message to the user. The text message may be in one of a set of message categories.

### BRIEF DESCRIPTION OF THE DRAWINGS

FIG. 1 is a schematic, pictorial representation of a user standing on a scale according to an illustrative embodiment;

FIG. 2 is a schematic, block diagram of the scale, and elements thereof, according to an illustrative embodiment;

FIG. 3 is a schematic, perspective view of a scale according to an illustrative embodiment; and

FIG. 4 is a flowchart of a process for displaying data on a scale according to an illustrative embodiment.

### DETAILED DESCRIPTION

In the following detailed description of the illustrative embodiments, reference is made to the accompanying drawings that form a part hereof. These embodiments are described in sufficient detail to enable those skilled, in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in limiting sense, and the scope of the illustrative embodiments are defined only by the appended claims.

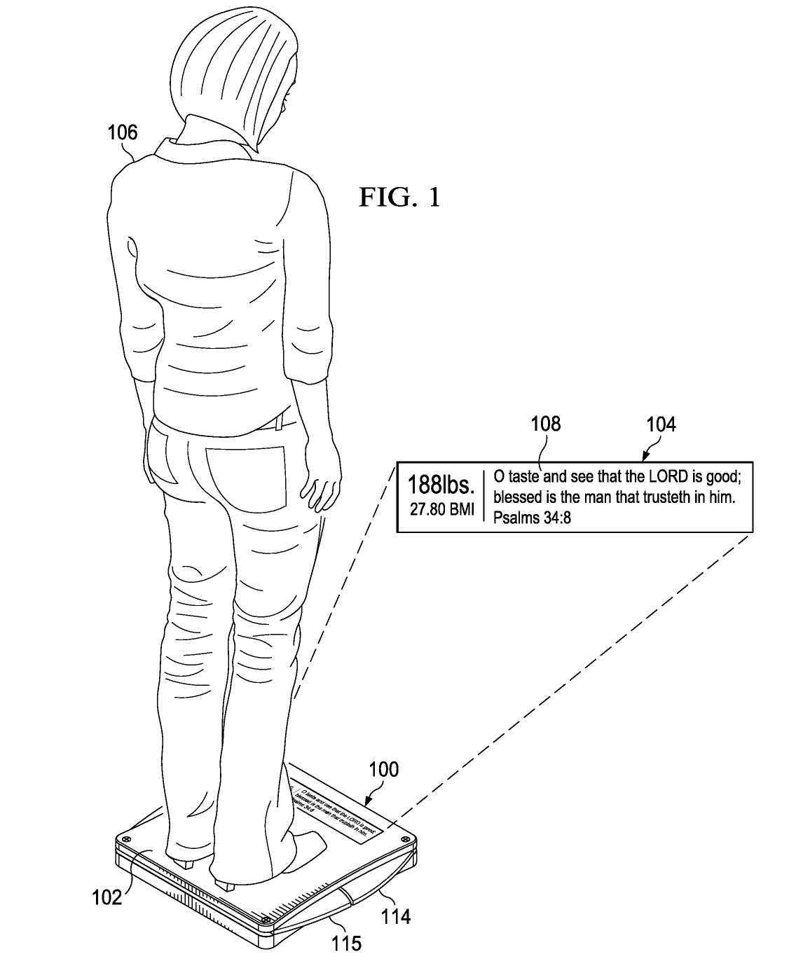

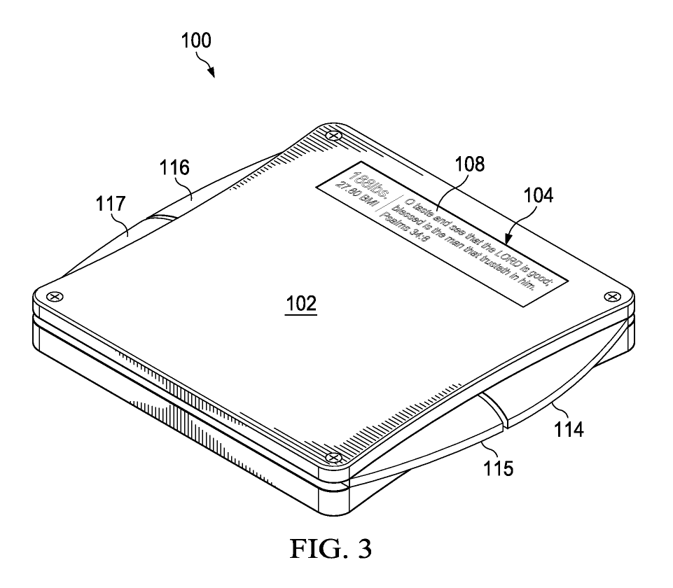

Referring to FIGS. 1 through 3, an illustrative embodiment of a scale 100 includes a platform 102 and a display 104. The platform 102 may be sized, structured, or adapted for a user 106 to step thereon, as shown in FIG. 1. Unless otherwise indicated, as used herein, “or” does not require mutual exclusivity. The display 104 may display or more body measurements of the user 106 including, but not limited to, the user's weight, body mass index (BMI), etc. The display 104 may also display the date, time, temperature, or other parameters.

In one embodiment, the display 104 may display or show a message 108, which is readable or viewable by the user 106. Each message 108 displayed by the display 104 may be stored in a storage 110. The storage 110 may store any number of messages in a set of message categories. As used herein, including in the claims, the term “set” encompasses a quantity of one or more. When the user 106 is on the platform 102, the display 104 may show a message from one of the set of message categories. An alarm or setting may also beset that could “voice” or audibly emit the message (such as scripture or an inspiration quote).

Numerous examples of message categories may be used in the illustrative embodiments. Non-limiting examples of message categories include inspirational quotes (e.g., motivational quotes, quotes from famous people, etc), religious passages (e.g., Bible verses), word of the day (e.g., words to help children broaden their vocabulary), foreign language word and/or translation of the day (e.g., a foreign word, and its translation, to help someone learn a foreign language), test questions (e.g., SAT, MCAT, or LSAT questions), trivia. (e.g., sports, movie, or music trivia), table manners, health tips, etc.

The scale 100 may include a message category selection module 112 to determine which of the set of message categories to be used to display the message 108 on the display 104. In one non-limiting example, the message category from which the message 108 is selected for display may be determined based on input from the user 106. In this example, the scale 100 may include a set of buttons 114, 115, 116, 117, one of which may be a message category selector button 114. The message category selector button 114 may be pressed by the user 106 to select which of the message categories from which to display the message 108 on the display 104. In one embodiment, the message category selector button 114 may be pressable by a foot of the user 106.

In non-limiting example, the user 106 may change the message-category by pressing on the message category selector button 114 once or repeatedly to scroll through the message categories stored in the storage 110. The use 106 may cease from scrolling through the message categories when the desired message category is displayed on the display 104, from which point messages from the selected message category may be displayed on the scale 100.

In another example, the message category may be changed in other ways. For example, the scale 100 may include one or more directional arrows that allow the user 106 to select or scroll through message categories on the display 104. Such directional arrows may be pressed by the user's hand or foot. In another example, the message category may be randomly selected by the message category selection module 112. As described below, the message category may also be selected by one or more communication devices 118 associated with the use 106. In another embodiment, a hand-held remote control may be used to change the message category; this hand-held remote control may include directional arrow buttons (e.g., up and down arrow keys) used for this purpose.

In one embodiment, the display 104 may present a different message each time the user 106 steps on the scale 100. However, other message frequencies may occur. For example, the same message may be displayed for a predetermined time period (e.g., one second, one minute, one day, one week, one month, etc.) regardless of whether or when the user 106 steps on the scale 100. Also, the message may display when the user 106 steps on the scale 100, and may disappear when no user 106 is present on the scale 100. However, in other examples, the message 108 may remain displayed even when the user 106 is not on the scale 100, or for some predetermined period of time before or after the user 106 steps on the scale 100.

Examples of the type of display 104 that may be used on the scale 100 are numerous. For example, the display 104 may utilize e-ink, digital ink, light emitting diodes (LEDs), plasma, OLED, or any other type of technology capable of displaying one or more characters. Also, the display 104 may be substantially flat or may be curved. In an embodiment in which the display 104 is curved, the display 104 may be concave or convex.

In one embodiment, the scale 100 may include an audio module 120. The audio module 120 may include a speaker, and may audibly emit various types of data associated with the scale 100. For example, the audio module 120 may emit audio of the weight or the body mass index of the user 106. In another embodiment, the audio module 120 may audibly emit the message 108 shown on the display 104. In an alternate embodiment, the message 108 may be audibly emitted by the audio module 120 in lieu of being displayed on the display 104. One example use of such audio emission is to assist the visually impaired, hearing impaired, or those unable to read.

In one embodiment, the scale 100 may also include a communication module 122 that may communicate data with a communication device 118 associated with the user 106 or any other device capable of sending or receiving data communication. The communication module 122 may communicate with the communication device 118 in numerous ways.

The techniques, technologies, or media by which the scale 100 and other communication devices intercommunicate are numerous. For example, the scale 100 and the communication device 118, or any portion(s) thereof, may be part of a personal area network (PAN), a local area network (LAN), a campus area network (CAN), a metropolitan area network (MAP), or any other network type. Also, communication between the scale 100 and the communication device 118 may be direct or indirect. The data communication medium between the scale 100 and the communication device 118 may be any medium through which data can be communicated. For example, the data communication medium may be wired or wireless data connections, and may utilize a virtual private network (VPN), multi-protocol label, switching (MPLS), the Internet, or any other data communication media wireless communication between the scale 100 and the communication device 118 may utilize any wireless standard for communicating data, such as COMA (e.g., cdmaOne or CDMA2000), GSM, 3G, 4G, Edge, an over-the-air network, Bluetooth, etc.

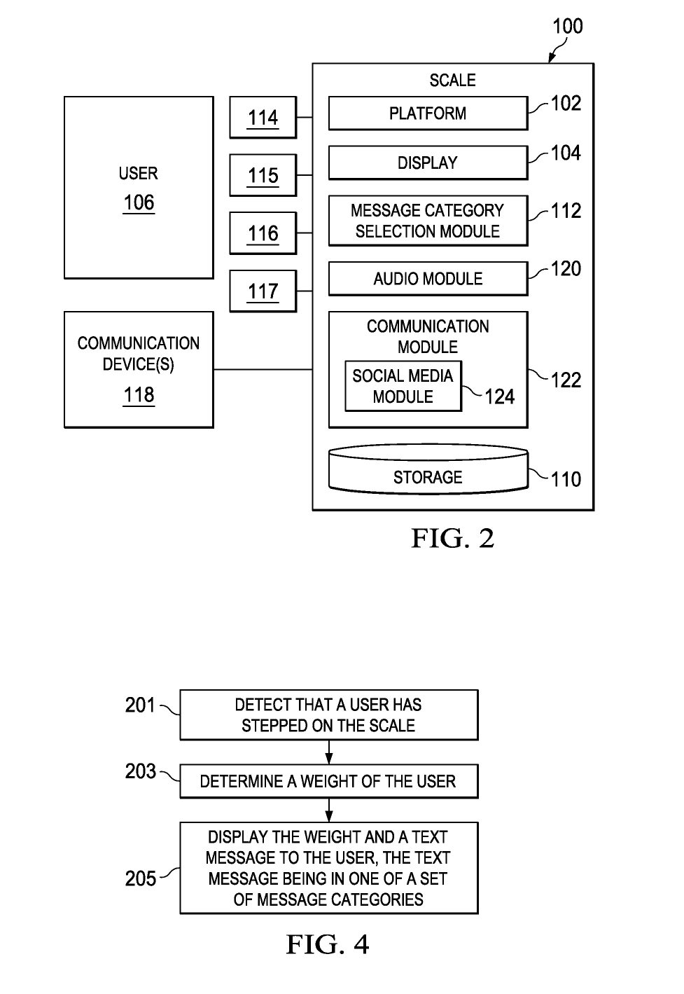

In one example, the scale 100 and communication device 118 may utilize the Internet, with the data communication media therebetween representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. FIG. 2 is intended as an example, and not as an architectural limitation for the different illustrative embodiments.

The communication module 122 may also include a universal serial bus (USB) port in which a USB cable may be coupled to allow for communication with another device, such as the communication device 118. Other wired forms or protocols for transmitting data between the scale 100 and other devices may also be used.

The communication device 118 may be any device capable of receiving or sending data. For example, the communication device 118 may be a computer (e.g., a laptop, netbook, tablet computer, desktop computer, or minicomputer), a cellular phone (e.g., a smart phone), a personal digital assistant, a kiosk, a portable gaming device, a web browsing device, a media player, etc.

In one embodiment, the communication module 122 may send the weight of the user 106 to the communication device 118. In one non-limiting example, each time the user 106 weighs himself or herself on the scale 100, the weight may be sent to the communication device 118. In another example, the weights of the user 106 recorded over a period of time by the scale 100 may be sent to the communication device 118 in batches. The communication device 118 may implement an application that allows user 106 to review his or her weights, and perform various operations on those weights, such as creating graphs, progress charts, progress reports, etc. Similarly the user's body mass index or any other body measurements may be sent to the communication device 118 for storage or further processing, including the application processing examples provided above. In another embodiment, the user 106 may send pertinent information (e.g., weight, body mass index, etc.) to a health care entity or physician for medical tracking (such as by an oncologist, bypass surgeon, etc.), or to a weight or fitness-oriented business (e.g., Weight Watchers) for tracking; in one example, this type of data may be sent to these entities or people in situations where the data is needed, but the user 106 may be unable to be present.

In another embodiment, the message 108 may be sent to the communication device 118 by communication module 122. To provide one non-limiting example, the communication module 122 may send an inspirational quote to a cell hone of the user 106 so that it can be accessed later by the user 106. In another example, the message category may be a type of question, such as SAT or other test question, and the test question which is displayed on the scale 100 may be sent to the communication device 118 so that the user 106 may answer the question on the communication device 118. Progress regarding correct or incorrect, answers provided by the user 106 may be stored or tracked by the application implemented on the communication device 118.

In addition to answering different types of questions presented by the message 108, the user 106 may edit any messages, or questions, that are sent to the communication device 118. Furthermore, a web or other application interface may be present on the communication device 118 that allows the user 106 to manage the message categories presented by the scale 100. For example, the user 106 may use the interface on the communication device 118 to determine which of the message categories should be selected from for display on the scale 100. This function may all the user 106 to change message categories over time as desired. The user 106 may also add or delete messages in any of the message categories on the scale 100. The user 106 may also use interface to upload any messages to the scale 100. For example, the communication device 118 may store one or more messages and one or more message categories the user 106 desires to be displayed on the scale 100; in this case, the user 106 may use the interface of the communication device 118 to upload those messages and message categories to storage 110 for subsequent display by the scale 100.

In another example, messages may be created by the user 106 and uploaded to the scale 100 via the communication device 118 and the communication module 122. For example, a parent may wish to create messages for his or her children that are encouraging or contain certain lessons. The scale 100 allows for such customization via the communication device 118, or directly on the scale 100.

In another embodiment, the message 108 displayed by the scale 100 may be dynamic based on body measurements made by the scale 100. For example, if the scale 100 determines that the user 106 has lost weight or has a lower BMI than normal, the scale 100 may display a congratulatory message (e.g., Good job!, Keep it up!, etc.). On the other hand, if the scale 100 detects that the user 106 has gained weight, as compared previous body measurements, the scale 100 may display an encouraging message (e.g., Don't give up!).

In another embodiment, the scale 100 may include speech recognition technology that allows the user 106 to answer questions presented in the message 108. For example, the display 104 may display a message 108 that poses a trivia question, and in return the use 106 may speak the answer to the scale 100, which recognizes whether the answer is correct or incorrect. The scale 100 may then indicate whether the user 106 provided a correct or incorrect, answer.

The communication module 122 may also include a social media module 124. The scale 100 may sync to social media applications to allow the user 106 to share messages, body measurements, other important information with their friends or family. In one embodiment, the social media module 124 may share at least one of the weight of the user 106 or the message 108 on a social media application (Facebook®, Twitter®, LinkedIn®, Foursquare®, etc.). For example, the user 106 may desire to post the message 108 as a Facebook® update, and one of the buttons 114, 115, 116, 117 of the scale 100 may be used to post such an update. Conversely, the display 104 may show social media updates from user's friends. The particular updates that are posted on the display 104 may be customized by the user 106. For example, the user 106 may customize settings so that only certain friends' updates are displayed on the scale 100.

The scale 100 may be powered in a variety of ways. In one embodiment, the scale 100 includes a battery charger socket which allows power to be transferred to a battery powering the scale 100. In another embodiment, the scale 100 may be powered directly from a wall source. In another embodiment, power may be provided to the scale 100 using the USB port that may be part of the communication module 122.

Computer-usable program code or instructions implementing the processes used in the illustrative embodiments may be located on the scale 100 and/or the communication device 118. The various modules and elements of the scale 100 and/or the communication device 118 may be implemented by a communications fabric, which may provide communications between a processor unit, a memory (e.g., storage 110), a persistent storage (e.g., storage 110), a communications unit (e.g., communication module 122), an input/output (I/O) unit (e.g., communication module 122), and/or a display (e.g., display 104).

Referring to FIG. 4, an illustrative embodiment of a process for displaying data a scale includes detecting that a user has stepped on the scale (step 201). The process may include determining a weight of the user (step 203). The process may also include displaying the weight and a message, text or otherwise, to the user (step 205). The text message may be in one of the set of message categories. The message category may be selected by the user or the scale itself.

In another embodiment, the process may include receiving input from the user to select the message category from which to display the text message. In yet another embodiment, the process may include syncing with one or more communication devices, which may be associated with the user, by sending at least one of the weight, the text message, or any other body measurement to the one or more communication devices.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the Figures. For example, in some cases, two blocks shown in succession may be executed substantially concurrently, or the blocks may sometimes be executed in the reverse order, depending upon the functionality involved.

Although the illustrative embodiments described herein have been disclosed in the context of certain illustrative, non limiting embodiments, it should be understood that various changes, substitutions, permutations, and alterations can be made without departing from the scope of the invention as defined by the appended claims. It will be appreciated that any feature that is described in a connection to any one embodiment may also be applicable to any other embodiment.

What is claimed is

1. A scale comprising:
a platform for a user to step thereon;
a display adapted to display a weight of the user, the display further adapted to display a message from one of a set of message categories at least when the user is on the platform.

2. The scale of claim 1, further comprising:
a message category selection module to determine which of the set of message categories used to display the message on the display.

3. The scale of claim 2, further comprising:
wherein the message category selection module determines which of the set of message categories used to display the message on the display using input from the user.

4. The scale of claim 3, further comprising:
a message category selector button pressable by a foot of the user to select which of the set of message categories from which to display the message on the display.

5. The scale of claim 1, further comprising:
a storage to store at least a portion of the messages in the set of message categories.

6. The scale of claim 5, wherein at least a portion of the messages in the set of message categories are uploaded to the storage by the user.

7. The scale of claim 1, wherein the set of message categories comprise at least one of inspirational quotes, religious passages, word of the day, foreign language word of the day, test questions, sports trivia, table manners, or health tips.

8. The scale of claim 1, wherein the display is further adapted to display a body mass index.

9. The scale of claim 1, further comprising:
a Universal Serial Bus (USB) port to enable communication between the scale and another device.

10. The scale of claim 1, further comprising:
an audio module comprising a speaker to audibly emit at least one of the weight or the message.

11. The scale of claim 1, further comprising:
a communication module to communicate with one or more communication devices associated with the user.

12. The scale of claim 11, wherein the communication module is adapted to send the weight of the user to the one or more communication devices.

13. The scale of claim 11, wherein the communication module is adapted to send the message to the one or more communication devices.

14. The scale of claim 11, wherein the communication module further comprises:
a social media module no share at least one of the weight or the message on a social media application.

15. The scale of claim 1, wherein the message is different each time the user steps on the scale.

16. A scale comprising:
a platform for a user to step thereon;
a display adapted to display a weight of the user, the display further adapted to display a quote from one of a set of quote categories at least when the user is on the platform.

17. A method for displaying data on a scale, the method comprising:
detecting that a user has stepped on the scale;
determining a weight of the user; and
displaying the weight and a text message to the user, the text message being in one of a set of message categories.

18. The method of claim 17, further comprising:
receiving input from user selecting the message category from which to display the text message.

19. The method of claim 17, further comprising:
syncing with one or more communication devices by sending at least one of the weight or the text message to the one or more communication devices.
